(19) United States
(12) Patent Application Publication
(10) Pub. No.: US 2011/0262625 A1
(43) Pub. Date: Oct. 27, 2011

(54) THIN FILM DEPOSITION APPARATUS

(76) Inventors: Hyun-Sook PARK, Yongin-City (KR); Chang-Mog Jo, Yongin-City (KR); Hee-Cheol Kang, Yongin-City (KR); Yun-Mi Lee, Yongin-City (KR); Un-Cheol Sung, Yongin-City (KR); Yong-Sup Choi, Yongin-City (KR); Jong-Heon Kim, Yongin-City (KR); Jae-Kwang Ryu, Yongin-City (KR)

(21) Appl. No.: 13/176,701

(22) Filed: Jul. 5, 2011

Related U.S. Application Data
(63) Continuation-in-part of application No. 12/979,656, filed on Dec. 28, 2010.

(30) Foreign Application Priority Data
Jan. 11, 2010 (KR) 10-2010-0002381

(51) Int. Cl. B05D 5/06; B05C 5/00

(52) U.S. Cl. 427/66; 118/301

(57) ABSTRACT

A thin film deposition apparatus including a chamber; a deposition source accommodated in the chamber and configured to discharge a deposition material; a deposition source nozzle unit located at a side of the deposition source and including a plurality of deposition source nozzles arranged in a first direction; and a patterning slit sheet located opposite the deposition source nozzle unit inside the chamber and including a plurality of patterning slits arranged in a second direction perpendicular to the first direction, the patterning slit sheet being spaced apart from the substrate, and the thin film deposition apparatus being configured to perform a deposition while at least one of the substrate or the thin film deposition apparatus moves relative to the other in the first direction.

### CROSS-REFERENCE TO RELATED APPLICATION(S)

This application is a Continuation-in-Part (CIP) of U.S. patent application Ser. No. 12/979,656, filed on Dec. 28, 2010, which claims priority to and the benefit of Korean Patent Application No. 10-2010-0002381, filed on Jan. 11, 2010, in the Korean Intellectual Property Office, the entire contents of which are incorporated herein by reference.

### BACKGROUND

1. Field

Embodiments of the present invention relate to a thin film deposition apparatus.

2. Description of Related Art

Organic light-emitting display devices have a larger viewing angle, better contrast characteristics, and a faster response speed than other display devices, and thus have drawn attention as a next-generation display device.

Organic light-emitting display devices generally have a stacked structure including an anode, a cathode, and an emission layer interposed between the anode and the cathode. The devices display images in color when holes and electrons, injected respectively from the anode and the cathode, recombine in the emission layer and thereby emitting light. However, it is difficult to achieve high light-emission efficiency with such a structure, and thus intermediate layers, including an electron injection layer, an electron transport layer, a hole transport layer, a hole injection layer, etc., are optionally interposed between the emission layer and the corresponding one of the electrodes.

Also, in practice, it is very difficult to form fine patterns in organic thin films such as the emission layer and the intermediate layers, and red, green, and blue light-emission efficiency varies according to the organic thin films. For these reasons, it is not easy to form an organic thin film pattern on a large substrate, such as a mother glass having a size of 5 G or greater, by using a conventional thin film deposition apparatus, and thus it is difficult to manufacture large organic light-emitting display devices having satisfactory driving voltage, current density, brightness, color purity, light-emission efficiency, and life-span characteristics. Thus, there is a desire for improvement in this regard.

An organic light-emitting display device includes intermediate layers, including an emission layer located between a first electrode and a second electrode that are arranged opposite to each other. The intermediate layers and the first and second electrodes may be formed using a variety of methods, one of which is a deposition method. When an organic light-emitting display device is manufactured by using the deposition method, typically a fine metal mask (FMM) having the same pattern as a thin film to be formed is arranged to closely contact a substrate, and a thin film material is deposited over the FMM in order to form the thin film having the desired pattern.

### SUMMARY

According to aspects of embodiments of the present invention, a thin film deposition apparatus may be easily manufactured, may be simply applied to produce large-sized display devices on a mass scale, and improves manufacturing yield and deposition efficiency.

According to an embodiment of the present invention, a thin film deposition apparatus for forming a thin film on a substrate includes a chamber; a deposition source accommodated in the chamber and configured to discharge a deposition material; a deposition source nozzle unit located at a side of the deposition source and including a plurality of deposition source nozzles arranged in a first direction; and a patterning slit sheet located opposite the deposition source nozzle unit inside the chamber and including a plurality of patterning slits arranged in a second direction perpendicular to the first direction, the patterning slit sheet being spaced apart from the substrate, and the thin film deposition apparatus being configured to perform a deposition while at least one of the substrate or the thin film deposition apparatus moves relative to the other in the first direction.

The thin film deposition apparatus may further include a first circulating unit configured to move an electrostatic chuck having the substrate attached thereto in the first direction.

The first circulating unit may include a frame accommodating the deposition source; and a sheet supporting unit protruding from an inner surface of the frame and supporting the patterning slit sheet.

An opening may be formed in an upper plate of the frame, and the deposition source may be configured to discharge the deposition material through the opening and the patterning slit sheet and deposit the deposition material on the substrate.

The deposition source may be on a lower plate of the frame that is located below the upper plate.

The sheet supporting unit may guide movement of the deposition material.

The first circulating unit may further include a guide supporting unit on the frame; a pair of guide rails arranged parallel to each other on the guide supporting unit; and one or more guide blocks combined with the guide rails.

The electrostatic chuck having the substrate attached thereto may be arranged on the guide blocks and may be configured to move the substrate back and forth in a straight line along the guide rails.

The thin film deposition apparatus may further include a loading unit configured to attach the substrate to the electrostatic chuck; and an unloading unit configured to separate the substrate from the electrostatic chuck after the deposition has been performed.

The deposition source may be configured to continuously deposit the deposition material on the substrate while the at least one of the substrate or the thin film deposition apparatus is moved relative to the other in the first direction.

The patterning slit sheet may be smaller than the substrate.

The thin film deposition apparatus may include a plurality of thin film deposition assemblies, and each of the thin film deposition assemblies may include the deposition source; the deposition source nozzle unit; and the patterning slit sheet.

The deposition sources of the plurality of thin film deposition assemblies may respectively contain different deposition materials.

In one embodiment, thin film deposition assemblies of the plurality of thin film deposition assemblies are configured to concurrently deposit the deposition materials contained in the respective deposition sources of the thin film deposition assemblies on the substrate.

The plurality of thin film deposition assemblies may include at least three thin film deposition assemblies, and deposition materials respectively contained in the deposition sources of the at least three thin film deposition assemblies may include materials for forming red, green, and blue emission layers.

Deposition temperatures of the deposition sources of the plurality of thin film deposition assemblies may be separately controllable.

Deposition amounts of the deposition materials discharged from the deposition sources of the plurality of thin film deposition assemblies may be separately controllable.

According to another embodiment of the present invention, a method of manufacturing a thin film on a substrate includes: discharging a deposition material from a deposition source through a plurality of first deposition source nozzles arranged in a first direction; arranging a patterning slit sheet having a plurality of patterning slits arranged in a second direction perpendicular to the first direction opposite the plurality of first deposition source nozzles and spaced apart from the substrate; passing the deposition material through the plurality of patterning slits of the patterning slit sheet and onto the substrate; and moving the substrate relative to the plurality of first deposition source nozzles and the patterning slit sheet in the first direction.

The method may further include: attaching the substrate to an electrostatic chuck; and moving the electrostatic chuck relative to the plurality of first deposition source nozzles and the patterning slit sheet in the first direction.

The method may further include: discharging another deposition material from another deposition source through a plurality of second deposition source nozzles arranged in the first direction; arranging another patterning slit sheet having a plurality of patterning slits arranged in the second direction opposite the plurality of second deposition source nozzles and spaced apart from the substrate; passing the another deposition material through the plurality of patterning slits of the another patterning slit sheet and onto the substrate concurrently with passing the deposition material through the plurality of patterning slits of the patterning slit sheet and onto the substrate; and moving the substrate relative to the plurality of second deposition source nozzles and the another patterning slit sheet in the first direction.

### BRIEF DESCRIPTION OF THE DRAWINGS

The above and other features and aspects of embodiments of the present invention will become more apparent by describing in detail some exemplary embodiments thereof with reference to the attached drawings in which:

FIG. 1 is a schematic perspective view of a thin film deposition apparatus according to an embodiment of the present invention;

FIG. 2 is a schematic side cross-sectional view of the thin film deposition apparatus of FIG. 1, according to an embodiment of the present invention;

FIG. 3 is a schematic front cross-sectional view of the thin film deposition apparatus of FIG. 1, according to an embodiment of the present invention;

FIG. 4 is a top view of a patterning slit sheet of a thin film deposition apparatus according to another embodiment of the present invention;

FIG. 5 is a top view of a patterning slit sheet of a thin film deposition apparatus according to another embodiment of the present invention;

FIG. 6 is a schematic perspective view of a thin film deposition apparatus according to another embodiment of the present invention;

FIG. 7 is a graph schematically illustrating a distribution pattern of a deposition layer formed on a substrate when a deposition source nozzle is not tilted, in a thin film deposition apparatus according to an embodiment of the present invention;

FIG. 8 is a graph schematically illustrating a distribution pattern of a deposition layer formed on a substrate when a deposition source nozzle is tilted, in a thin film deposition apparatus according to an embodiment of the present invention;

FIG. 9 is a schematic perspective view of a thin film deposition apparatus according to another embodiment of the present invention;

FIG. 10 is a schematic perspective view of a thin film deposition apparatus according to another embodiment of the present invention;

FIG. 11 is a schematic perspective view of a thin film deposition apparatus according to another embodiment of the present invention;

FIG. 12 is a schematic perspective view of a thin film deposition apparatus according to another embodiment of the present invention;

FIG. 13 is a schematic perspective view of a thin film deposition apparatus according to another embodiment of the present invention;

FIG. 14 is a cross-sectional view of an active matrix-type organic light emitting display device fabricated by using a thin film deposition apparatus according to an embodiment of the present invention;

FIG. 15 is a schematic system diagram of a thin film deposition apparatus according to another embodiment of the present invention;

FIG. 16 is a schematic diagram of an electrostatic chuck of the thin film deposition apparatus of FIG. 15;

FIG. 17 is a schematic perspective view of a first circulating unit and a first thin film deposition assembly of the thin film deposition apparatus of FIG. 15; and

FIG. 18 is a front sectional view of the first circulating unit and the first thin film deposition assembly of the thin film deposition apparatus of FIG. 17.

### DETAILED DESCRIPTION

The present invention will now be described more fully with reference to the accompanying drawings, in which some exemplary embodiments of the present invention are shown. However, embodiments of the present invention may be embodied in different forms and should not be construed as limited to the exemplary embodiments illustrated and set forth herein. Rather, these exemplary embodiments are provided by way of example for understanding of the invention.

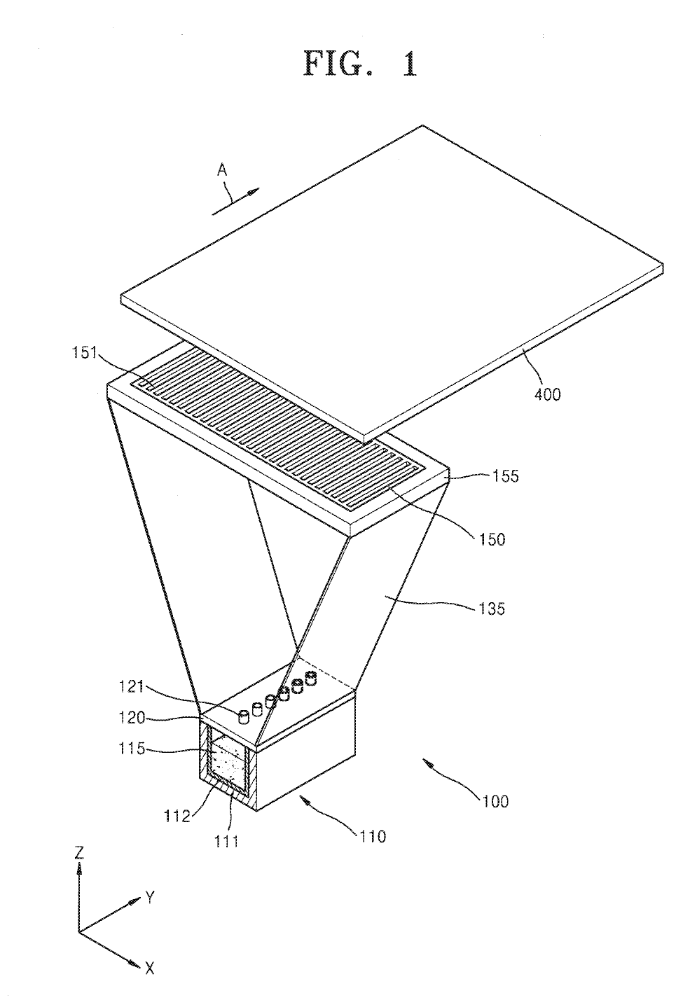

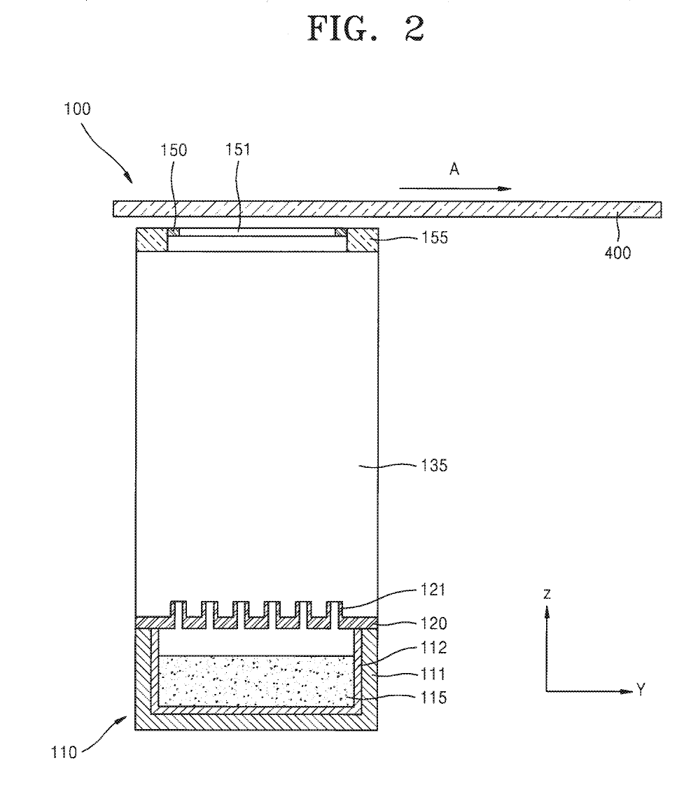

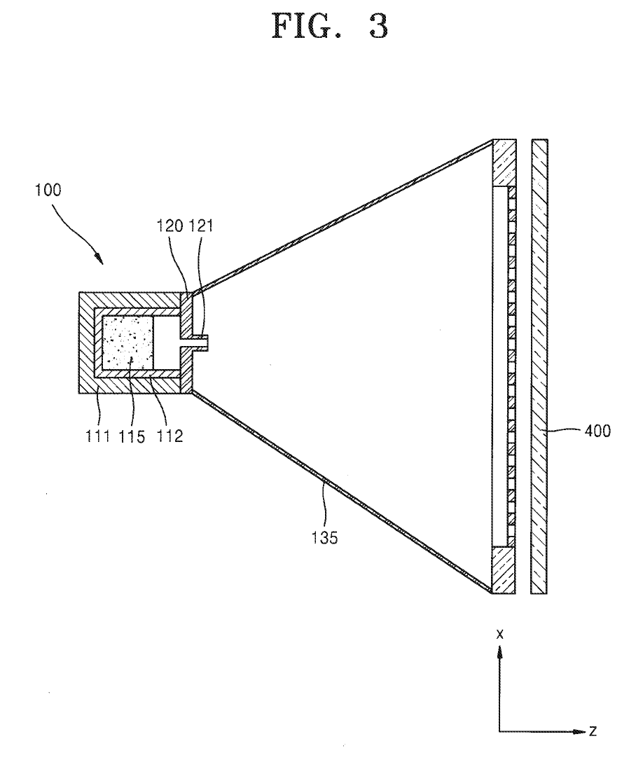

FIG. 1 is a schematic perspective view of a thin film deposition apparatus 100 according to an embodiment of the present invention, FIG. 2 is a schematic side view of the thin film deposition apparatus 100, and FIG. 3 is a schematic plan view of the thin film deposition apparatus 100.

Referring to FIGS. 1, 2 and 3, the thin film deposition apparatus 100 according to the current embodiment of the present invention includes a deposition source 110, a deposition source nozzle unit 120, and a patterning slit sheet 150.

Although a chamber is not illustrated in FIGS. 1, 2 and 3 for the convenience of explanation, all the components of the thin film deposition apparatus 100 may be located within a chamber that is maintained at an appropriate degree of vacuum. The chamber is maintained at an appropriate vacuum in order to allow a deposition material to move in a substantially straight line through the thin film deposition apparatus 100.

In particular, in order to deposit a deposition material 115 that is emitted from the deposition source 110 and is discharged through the deposition source nozzle unit 120 and the patterning slit sheet 150, onto a substrate 400 in a desired pattern, the chamber is maintained in a high-vacuum state as in a deposition method using a fine metal mask (FMM). In addition, the temperature of the patterning slit sheet 150 should be sufficiently lower than the temperature of the deposition source 110. In this regard, the temperature of the patterning slit sheet 150 may be about 100° C. or less. The temperature of the patterning slit sheet 150 should be sufficiently low so as to reduce thermal expansion of the patterning slit sheet 150.

The substrate 400, which constitutes a target on which the deposition material 115 is to be deposited, is located in the chamber. The substrate 400 may be a substrate for flat panel displays. A large substrate, such as a mother glass for manufacturing a plurality of flat panel displays, may be used as the substrate 400. Other substrates may also be employed.

In the current embodiment of the present invention, deposition may be performed while at least one of the substrate 400 or the thin film deposition apparatus 100 is moved relative to the other.

In particular, in the conventional FMM deposition method, the size of the FMM is typically equal to the size of a substrate. Thus, the size of the FMM is increased as the substrate becomes larger. However, it is neither straightforward to manufacture a large FMM nor to extend an FMM to be accurately aligned with a pattern.

In order to overcome this problem, in the thin film deposition apparatus 100 according to the current embodiment of the present invention, deposition may be performed while the thin film deposition apparatus 100 or the substrate 400 is moved relative to the other. In other words, deposition may be continuously performed while the substrate 400, which is arranged such as to face the thin film deposition apparatus 100, is moved in a Y-axis direction. For example, deposition may be performed in a scanning manner while the substrate 400 is moved in a direction of arrow A in FIG. 1. Although the substrate 400 is illustrated as being moved in the Y-axis direction in FIG. 1 while deposition is being performed, the present invention is not limited thereto. Deposition may be performed while the thin film deposition apparatus 100 is moved in the Y-axis direction, whereas the substrate 400 is fixed.

Thus, in the thin film deposition apparatus 100 according to the current embodiment of the present invention, the patterning slit sheet 150 may be smaller (e.g., significantly smaller) than a FMM used in a conventional deposition method. In other words, in the thin film deposition apparatus 100 according to the current embodiment of the present invention, deposition is continuously performed (e.g., in a scanning manner) while the substrate 400 is moved in the Y-axis direction. Thus, lengths of the patterning slit sheet 150 in the X-axis and/or Y-axis directions may be less (e.g., significantly less) than the lengths of the substrate 400 in the X-axis and Y-axis directions. As described above, since the patterning slit sheet 150 may be formed to be smaller (e.g., significantly smaller) than an FMM used in a conventional deposition method, it is relatively easy to manufacture the patterning slit sheet 150 used in embodiments of the present invention. In other words, using the patterning slit sheet 150, which is smaller than an FMM used in a conventional deposition method, is more convenient in all processes, including etching and subsequent other processes, such as precise extension, welding, moving, and cleaning processes, compared to the conventional deposition method using the larger FMM. This is more advantageous for a relatively large display device.

In order to perform deposition while the thin film deposition apparatus 100 or the substrate 400 is moved relative to the other as described above, the thin film deposition apparatus 100 and the substrate 400 may be separated from each other (e.g., separated by a predetermined distance). This will be described later in further detail.

The deposition source 110 that contains and heats the deposition material 115 is located at an opposite side of the chamber to that at which the substrate 400 is located. As the deposition material 115 contained in the deposition source 110 is vaporized, the deposition material 115 is deposited on the substrate 400.

For example, the deposition source 110 includes a crucible 111 that is filled with the deposition material 115, and a heater 112 that heats the crucible 111 to vaporize the deposition material 115, which is contained in the crucible 111, toward a side of the crucible 111, and in particular, toward the deposition source nozzle unit 120.

The deposition source nozzle unit 120 is located at a side of the deposition source 110, and in particular, at the side of the deposition source 110 facing the substrate 400. In addition, the deposition source nozzle unit 120 includes a plurality of deposition source nozzles 121 arranged at intervals (e.g., equal or substantially equal intervals) in the Y-axis direction, that is, the scanning direction of the substrate 400. The deposition material 115 that is vaporized in the deposition source 110, passes through the deposition source nozzle unit 120 toward the substrate 400. As described above, when the plurality of deposition source nozzles 121 are formed on the deposition source nozzle unit 120 in the Y-axis direction, that is, the scanning direction of the substrate 400, a size of the pattern formed by the deposition material that is discharged through each of patterning slits 151 in the patterning slit sheet 150 is only affected by the size of one deposition source nozzle 121, that is, it may be considered that one deposition nozzle 121 exists in the X-axis direction, and thus there is no shadow zone on the substrate 400. In addition, since the plurality of deposition source nozzles 121 are formed in the scanning direction of the substrate 400, even if there is a difference between fluxes of the deposition source nozzles 121, the difference may be compensated for and deposition uniformity may be maintained constant.

The patterning slit sheet 150 and a frame 155 in which the patterning slit sheet 150 is bound are located between the deposition source 110 and the substrate 400. The frame 155 may be formed in a lattice shape, similar to a window frame. The patterning slit sheet 150 is bound inside the frame 155. The patterning slit sheet 150 includes a plurality of patterning slits 151 arranged in the X-axis direction. The deposition material 115 that is vaporized in the deposition source 110 passes through the deposition source nozzle unit 120 and the patterning slit sheet 150 toward the substrate 400. The patterning slit sheet 150 may be manufactured by etching, which is the same method as used in a conventional method of manufacturing an FMM, and in particular, a striped FMM. The total number of patterning slits 151 may be greater than the total number of deposition source nozzles 121.

In addition, the deposition source 110 (and the deposition source nozzle unit 120 coupled to the deposition source 110) and the patterning slit sheet 150 may be formed to be separated from each other (e.g., separated by a predetermined distance). Alternatively, the deposition source 110 (and the deposition source nozzle unit 120 coupled to the deposition source 110) and the patterning slit sheet 150 may be connected by a connection member 135. That is, the deposition source 110, the deposition source nozzle unit 120, and the patterning slit sheet 150 may be formed integrally with each other by being connected to each other via the connection member 135. The connection member 135 guides the deposition material 115, which is discharged through the deposition source nozzles 121, to move straight and not flow in the X-axis direction. In FIGS. 1 through 3, the connection members 135 are formed on left and right sides of the deposition source 110, the deposition source nozzle unit 120, and the patterning slit sheet 150 to guide the deposition material 115 not to flow in the X-axis direction; however, the present invention is not limited thereto. That is, in another embodiment, the connection member 135 may be formed as a sealed type having a box shape to guide flow of the deposition material 115 in the X-axis and Y-axis directions.

As described above, the thin film deposition apparatus 100 according to the current embodiment of the present invention performs deposition while being moved relative to the substrate 400. In order to move the thin film deposition apparatus 100 relative to the substrate 400, the patterning slit sheet 150 is separated from the substrate 400 (e.g., separated by a predetermined distance).

For example, in a conventional deposition method using an FMM, deposition is performed with the FMM in close contact with a substrate in order to prevent formation of a shadow zone on the substrate. However, when the FMM is used in close contact with the substrate, the contact may cause defects. In addition, in the conventional deposition method, the size of the mask is typically the same as the size of the substrate since the mask cannot be moved relative to the substrate. Thus, the size of the mask has to be increased as display devices become larger. However, it is not easy to manufacture such a large mask.

In order to overcome this problem, in the thin film deposition apparatus 100 according to the current embodiment of the present invention, the patterning slit sheet 150 is arranged to be separated from the substrate 400 (e.g., separated by a predetermined distance).

As described above, according to embodiments of the present invention, a mask is formed to be smaller than a substrate, and deposition is performed while the mask is moved relative to the substrate. Thus, the mask can be easily manufactured. In addition, defects caused due to contact between a substrate and an FMM, which occur in the conventional deposition method, may be prevented. In addition, since it is unnecessary to use the FMM in close contact with the substrate during a deposition process, the manufacturing speed may be improved.

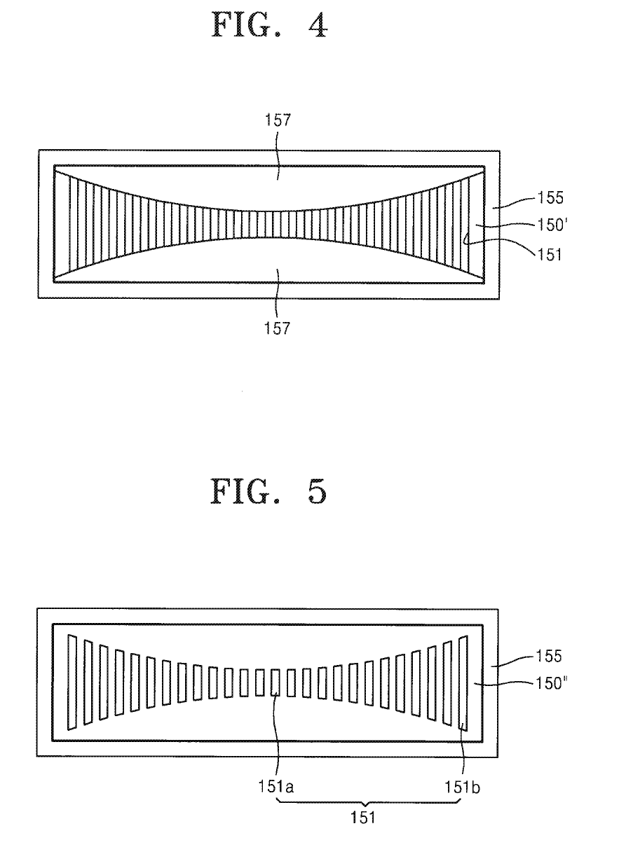

FIG. 4 is a plan view of a patterning slit sheet 150′ in the thin film deposition apparatus, according to another embodiment of the present invention. In the current embodiment of the present invention, a correction plate 157 is further located at a side of the patterning slit sheet 150′.

In particular, a thin film deposition apparatus of one embodiment of the present invention may further include the correction plate 157 in order to ensure uniformity of films formed on the substrate. In discharging an organic material (deposition material), the largest amount of organic material is discharged through a portion that is perpendicular to the deposition source nozzles 121 (see FIG. 1) and the amount of discharged organic material is gradually reduced toward both ends of the patterning slit sheet 150 according to cosine law. Thus, a deposition layer having a bulging center portion may be formed by a thin film deposition apparatus when the thin film deposition apparatus does not include the correction plate 157.

In order to remove the unevenness in thickness of the deposition layer, the correction plate 157 as shown in FIG. 4 may be located at a side or at two opposite sides of the patterning slit sheet 150′. The correction plate 157 is formed on a surface of the patterning slit sheet 150′ as a circular arc or a cosine curve. The correction plate 157 blocks some of the deposition material 115 discharged from the deposition source nozzles 121 (see FIG. 1) toward the patterning slits 151 (see FIG. 1).

That is, since the deposition layer formed by the thin film deposition apparatus would have a bulging center portion, some of the deposition material discharged toward the center portion of the patterning slit sheet 150′ should be blocked in order to form the deposition layer of a uniform thickness. Therefore, the correction plate 157 is located at a portion of the path of the deposition material in order to block some of the deposition material. Here, since the correction plate 157 is formed to have a circular arc or a cosine curve shape, the deposition material discharged toward the center portion of the patterning slit sheet 150′ is blocked more than the deposition material discharged toward left and right side portions of the patterning slit sheet 150′. The correction plate 157 may be arranged so that the thinnest part of the deposition layer, that is, parts of the deposition layer formed by the deposition material discharged through both sides of the patterning slit sheet 150′, becomes the entire thickness of the deposition layer.

As described above, since the correction plate 157 is located at a portion of the flow path of the deposition material, the deposition layer formed by the thin film deposition apparatus may be corrected. That is, a height of the correction plate 157 may be increased in order to block a large amount of deposition material at a portion where a large amount of deposition material is deposited, and the height of the correction plate 157 is reduced in order to block less deposition material at portions where less deposition material is deposited. Thus, the deposition amount of the deposition material may be adjusted so that the thickness of the deposition layer may be uniform or substantially uniform.

According to the current embodiment of the present invention, the uniformity of the thin film formed on the substrate is within an error range of about 1% to about 2%, and thus, quality and reliability of the thin film deposition apparatus may be improved.

FIG. 5 is a plan view of a patterning slit sheet 150″ in a thin film deposition apparatus according to another embodiment of the present invention. In the current embodiment of the present invention, a length of a patterning slit 151a located at a center portion of the patterning slit sheet 150″ is less than lengths of patterning slits 151b located at both end portions of the patterning slit sheet 150″ in order to provide uniformity of the thin films formed on the substrate.

As described above, the deposition amount of the deposition material may be adjusted so that the thickness of the entire deposition layer may be constant or substantially constant by using the patterning slit sheet 150″, in which the length of the patterning slit 151a at the center portion and the lengths of the patterning slits 151b at both ends of the patterning slit sheet 150″ may be different from each other, like in the previously described embodiment. In the thin film deposition apparatus according to the current embodiment of the present invention, the uniformity of the thin film formed on the substrate 400 is within an error range of about 1% to about 2%, and thus, quality and reliability of the thin film deposition apparatus 100 may be improved.

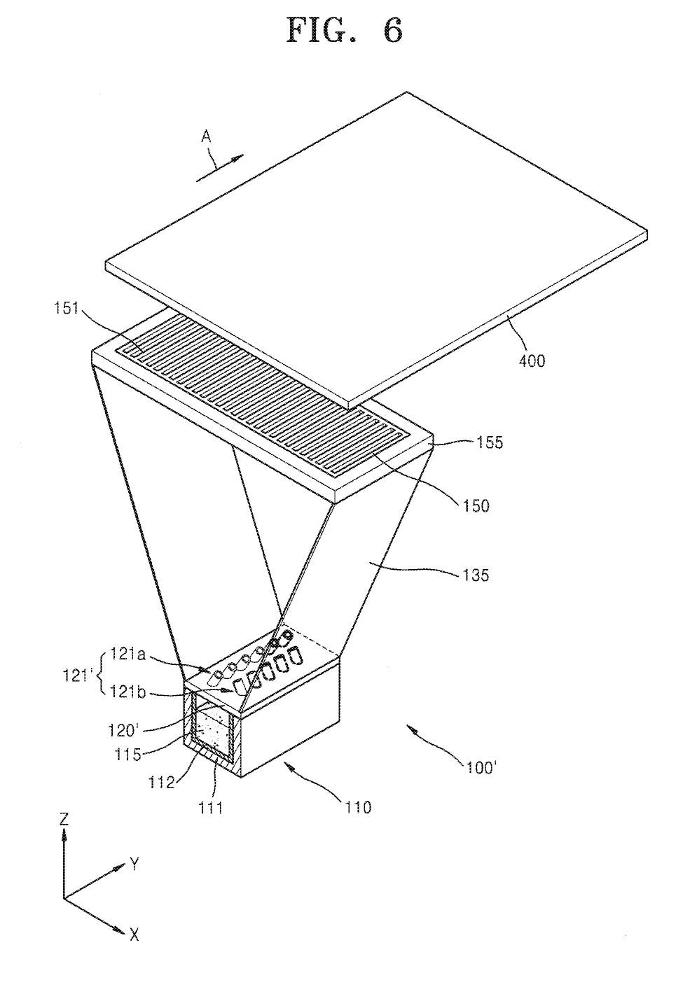

FIG. 6 is a perspective view of a thin film deposition apparatus 100′ according to another embodiment of the present invention. Referring to FIG. 6, the thin film deposition apparatus 100′ according to the current embodiment of the present invention includes the deposition source 110, a deposition source nozzle unit 120′, and the patterning slit sheet 150. In particular, the deposition source 110 includes the crucible 111 that is filled with the deposition material 115, and the heater 112 that heats the crucible 111 to vaporize the deposition material 115, which is contained in the crucible 111, toward a side of the crucible 111, and in particular, toward the deposition source nozzle unit 120′. The deposition source nozzle unit 120′, which has a planar shape, is located at a side of the deposition source 110. The deposition source nozzle unit 120′ includes a plurality of deposition source nozzles 121′ arranged in the Y-axis direction. The patterning slit sheet 150 and the frame 155 are further located between the deposition source 110 and the substrate 400, and the patterning slit sheet 150 includes the plurality of patterning slits 151 arranged in the X-axis direction. The deposition source 110, the deposition source nozzle unit 120′, and the patterning slit sheet 150, in one embodiment, are connected to each other by the connection member 135.

In the current embodiment of the present invention, the plurality of deposition source nozzles 121 formed on the deposition source nozzle unit 120′ are tilted (e.g., tilted at a predetermined angle). In particular, the deposition source nozzles 121′ may include deposition source nozzles 121a and 121b which are arranged in two rows, which are arranged opposite each other. Here, the deposition source nozzles 121a and 121b may be tilted (e.g., tilted at a predetermined angle) on an X-Z plane.

If the correction plate 157 (see FIG. 4) is used or the lengths of the patterning slits 151a and 151b (see FIG. 5) are different from each other like in the above described embodiments, an efficiency of utilizing deposition material may be degraded because the deposition material is blocked by the correction plate 157 or the patterning slits 151a and 151b. Therefore, in the current embodiment of the present invention, the deposition source nozzles 121a and 121b are arranged having tilted orientations (e.g., tilted at a predetermined angle). Here, the deposition source nozzles 121a in a first row may be tilted toward the deposition nozzles 121b in a second row, and the deposition source nozzles 121b in the second row may be tilted toward the deposition source nozzles 121a in the first row. That is, the deposition source nozzles 121a arranged in the row at the left side of the patterning slit sheet 150 are arranged to face the right side of the patterning slit sheet 150, and the deposition source nozzles 121b arranged in the row at the right side of the patterning slit sheet 150 are arranged to face the left side of the patterning slit sheet 150.

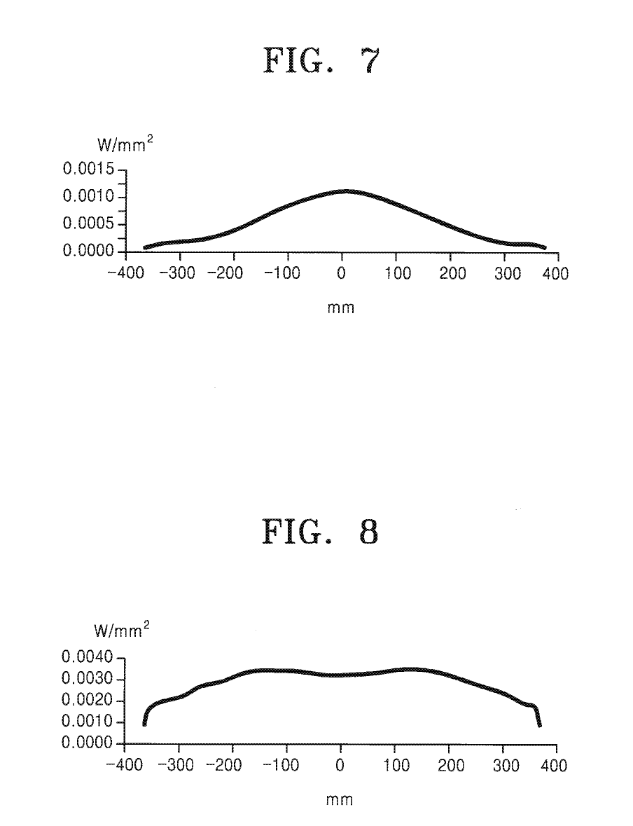

FIG. 7 is a graph showing a distribution of the deposition layer formed on the substrate when the deposition source nozzles are not tilted, in a thin film deposition apparatus according to one embodiment of the present invention, and FIG. 8 is a graph showing a distribution of the deposition layer formed on the substrate when the deposition source nozzles are tilted, in a thin film deposition apparatus according to another embodiment of the present invention. When comparing the graphs of FIGS. 7 and 8 with each other, thickness of the deposition layer formed on both end portions of the substrate when the deposition source nozzles are tilted is relatively greater than that of the deposition layer formed on the substrate when the deposition source nozzles are not tilted, and thus, the uniformity of the deposition layer is improved.

Therefore, the deposition amount of the deposition material may be adjusted so that a difference between the thicknesses of the deposition layer at the center portion and end portions of the substrate may be reduced and the entire thickness of the deposition layer may be constant or substantially constant, and moreover, the efficiency of utilizing the deposition material may be improved.

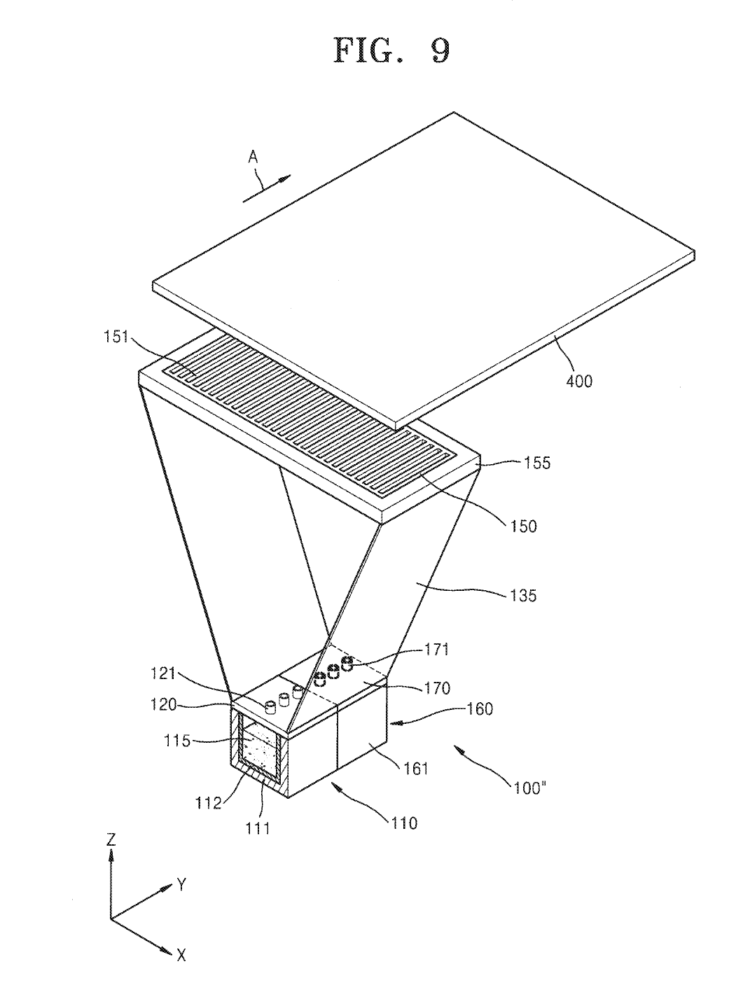

FIG. 9 is a schematic perspective view of a thin film deposition apparatus 100″ according to another embodiment of the present invention. Referring to FIG. 9, the thin film deposition apparatus 100″ according to the current embodiment of the present invention includes a first deposition source 110, a first deposition source nozzle unit 120, a second deposition source 160, a second deposition source nozzle unit 170, and the patterning slit sheet 150. The patterning slit sheet 150 and the frame 155 are located between the first deposition source 110 and the second deposition source 160, and the substrate 400, and the patterning slit sheet 150 includes the plurality of patterning slits 151 arranged in the X-axis direction. Alternatively to the patterning slit sheet 150, the thin film deposition apparatus 100″ may include one of the patterning slit sheets 150′ and 150″ described above. In addition, the first deposition source 110, the second deposition source 160, the first deposition source nozzle unit 120, the second deposition source nozzle unit 170, and the patterning slit sheet 150, in one embodiment, are connected to each other by the connection member 135.

In the thin film deposition apparatus 100″ according to the current embodiment of the present invention, the first deposition source 110 contains a host material 115 and the second deposition source 160 contains a dopant material (not shown) so that the host material 115 and the dopant material may be concurrently (e.g., simultaneously) deposited on the substrate 400. That is, since the host material 115 and the dopant material (not shown) are vaporized at different temperatures from each other, the plurality of deposition sources 110 and 160 and the plurality of deposition source nozzle units 120 and 170 are provided to deposit the host material 115 and the dopant material concurrently (e.g., at the same time).

In particular, the first deposition source 110 and the second deposition source 160 that contain and heat the deposition materials are located at an opposite side of the chamber to that at which the substrate 400 is located. As the deposition materials contained in the first deposition source 110 and the second deposition source 160 are vaporized, the deposition materials are deposited on the substrate 400. In particular, the first deposition source 110 includes a crucible 111 that is filled with the host material 115, and a heater 112 that heats the crucible 111 to vaporize the host material 115, which is contained in the crucible 111, toward a side of the crucible 111, and in particular, toward the first deposition source nozzle unit 120. The second deposition source 160 includes a crucible 161 that is filled with the dopant material (not shown), and a heater (not shown) that heats the crucible 161 to vaporize the dopant material (not shown), which is contained in the crucible 161, toward a side of the crucible 161, and in particular, toward the second deposition nozzle unit 170.

Examples of the host material may include tris(8-hydroxy-quinolinato)aluminum (Alq3), 9,10-di(naphth-2-yl)anthracene (AND), 3-tert-butyl-9,10-di(naphth-2-yl)anthracene (TBADN), 4,4′-bis(2,2-diphenyl-ethene-1-yl)-4,4′-dimethylphenyl (DPVBi), 4,4′-bis(2,2-diphenyl-ethene-1-yl)-4,4′-dimethylphenyl (p-DMDPVBi), tert(9,9-diarylfluorene)s (TDAF), 2-(9,9′-spirobifluorene-2-yl)-9,9′-spirobifluorene(BSDF), 2,7-bis(9,9′-spirobifluorene-2-yl)-9,9′-spirobifluorene (TSDF), bis(9,9-diarylfluorene)s (BDAF), 4,4′-bis(2,2-diphenyl-ethene-1-yl)-4,4′-di-(tert-butyl)phenyl (p-TDPVBi), 1,3-bis(carbazol-9-yl)benzene (mCP), 1,3,5-tris(carbazol-9-yl)benzene (tCP), 4,4′,4″-tris(carbazol-9-yl)triphenylamine (TcTa), 4,4′-bis(carbazol-9-yl)biphenyl (CBP), 4,4′-bis(9-carbazolyl)-2,2′-dimethyl-biphenyl (CBDP), 4,4′-bis(carbazol-9-yl)-9,9-dimethyl-fluorene (DMFL-CBP), 4,4′-bis(carbazol-9-yl)-9,9-bis(9-phenyl-9H-carbazol)fluorene (FL-4CBP), 4,4′-bis(carbazol-9-yl)-9,9-di-tolyl-fluorene (DPFL-CBP), 9,9-bis(9-phenyl-9H-carbazol)fluorene (FL-2CBP), etc.

Examples of the dopant material may include DPAVBi (4,4′-bis[4-(di-p-tolylamino)styryl]biphenyl), ADN (9,10-di(naph-2-tyl)anthracene), TBADN (3-tert-butyl-9,10-di(naph-2-tyl)anthracene), etc.

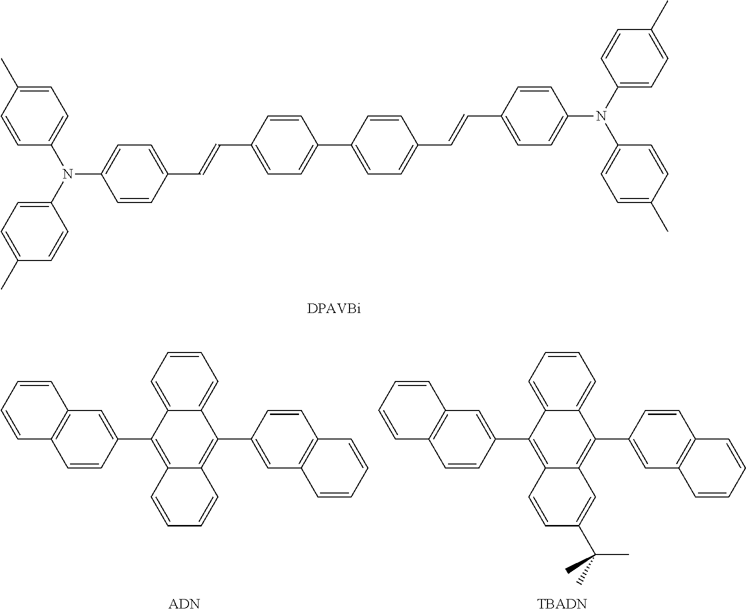

As described above, the thin film deposition apparatus 100″ according to the current embodiment of the present invention is characterized in that the first deposition source 110 that contains the host material 115 and the second deposition source 160 that contains the dopant material (not shown) are provided so that the host material 115 and the dopant material may be concurrently (e.g., simultaneously) deposited on the substrate 400. Since the host material 115 and the dopant material may be concurrently (e.g., simultaneously) deposited on the substrate 400, the deposition process may be simplified and performed rapidly, and device efficiency may be improved.

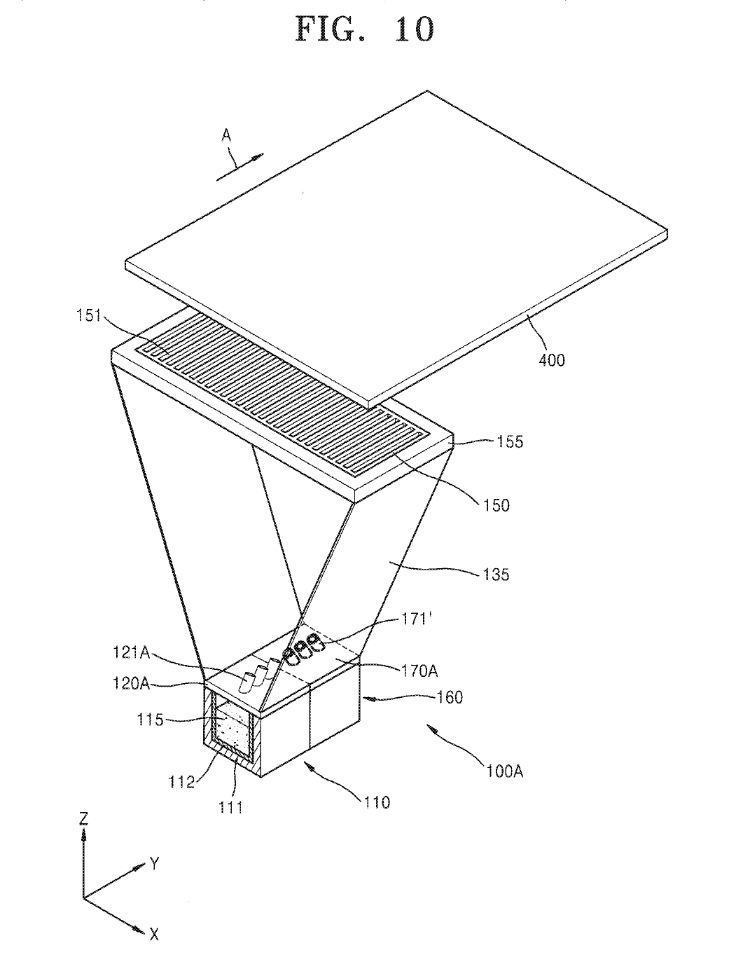

FIG. 10 is a schematic perspective view of a thin film deposition apparatus 100A according to another embodiment of the present invention. Referring to FIG. 10, the thin film deposition apparatus 100A according to the current embodiment of the present invention includes the first deposition source 110, a first deposition source nozzle unit 120A, the second deposition source 160, a second deposition source nozzle unit 170A, and the patterning slit sheet 150. The patterning slit sheet 150 and the frame 155 are located between the first and second deposition sources 110 and 160 and the substrate 400, and the patterning slit sheet 150 includes the plurality of patterning slits 151 arranged in the X-axis direction. Alternatively to the patterning slit sheet 150, the thin film deposition apparatus 100A may include one of the patterning slit sheets 150′ and 150″ described above. In addition, the first and second deposition sources 110 and 160, the first and second deposition source nozzle units 120A and 170A, and the patterning slit sheet 150, in one embodiment, are connected to each other by the connection member 135. In the thin film deposition apparatus 100A according to the current embodiment of the present invention, the first deposition source 110 contains the host material 115 and the second deposition source 160 contains a dopant material (not shown) so that the host material 115 and the dopant material may be concurrently (e.g., simultaneously) deposited on the substrate 400.

The thin film deposition apparatus 100A of the current embodiment of the present invention is different from that of the previous embodiments in that a plurality of deposition source nozzles 121 A and 171′ which are respectively formed on the first and second deposition source nozzle units 120A and 170A are tilted (e.g., tilted at a predetermined angle). That is, the deposition source nozzles 121A and 171′ may be tilted (e.g., tilted at a predetermined angle) on a Y-Z plane.

Although a content of the dopant material may vary depending on the material forming thin films, the dopant material may be contained by about 3 parts to about 20 parts by weight in the thin film forming material (total weight of the host and dopant materials) of 100 parts by weight. If the content of the dopant material exceeds the above described range, the light emitting property of an organic light emitting display device may be degraded. However, when the deposition source nozzles 121 and 171 are arranged in parallel with the Z-axis like in the embodiment described with reference to FIG. 9, the dopant material is deposited on the substrate 400 at an initial stage of the deposition process, the dopant material and the host material are alternatively deposited on the substrate 400 at an intermediate stage of the deposition process, and the host material is deposited on the substrate 400 at an end stage of the deposition process. That is, mixture ratios of the host material and the dopant material may vary depending on regions of the substrate 400.

Thus, in the thin film deposition apparatus 100A according to the current embodiment of the present invention, the deposition source nozzles 121A and 171′ are tilted (e.g., tilted at a predetermined angle). The deposition source nozzles 121A of the first deposition source nozzle unit 120A and the deposition source nozzles 171′ of the second deposition source nozzle unit 170A may be tilted to face each other. That is, the deposition source nozzles 121A of the first deposition source nozzle unit 120A may be tilted to face the second deposition source nozzle unit 170A, and the deposition source nozzles 171 of the second deposition source nozzle unit 170A may be tilted to face the first deposition source nozzle unit 120A.

Through the above described structure, the mixing ratio of the host material 115 and the dopant material in the deposition material may be constant or substantially constant throughout the entire substrate 400. In addition, if the thin films are formed by using the mixture in which the host material 115 and the dopant material are mixed with a constant or substantially constant mixture ratio, the thin films may represent improved characteristics in view of color coordinate, optical efficiency, driving voltage, and lifespan.

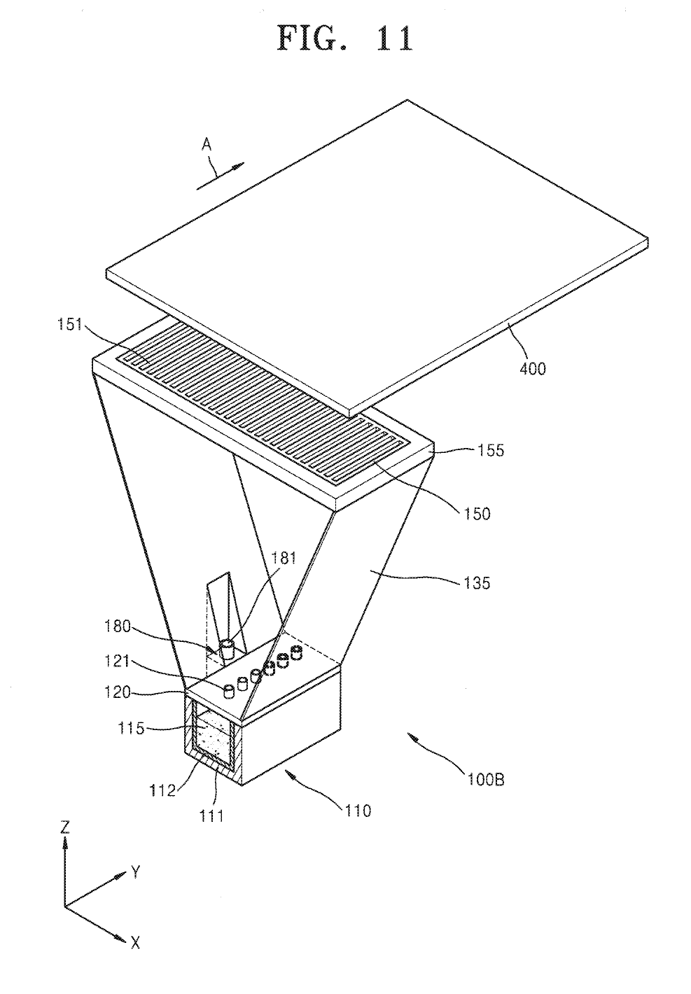

FIG. 11 is a schematic perspective view of a thin film deposition apparatus 100B according to another embodiment of the present invention. Referring to FIG. 11, the thin film deposition apparatus 100B according to the current embodiment of the present invention includes a first deposition source 110, a first deposition source nozzle unit 120, a second deposition source 180, a second deposition source nozzle 181, and the patterning slit sheet 150. The patterning slit sheet 150 and the frame 155 are located between the first and second deposition sources 110 and 180 and the substrate 400, and the patterning slit sheet 150 includes the plurality of patterning slits 151 arranged in the X-axis direction. Alternatively to the patterning slit sheet 150, the thin film deposition apparatus 100B may include one of the patterning slit sheets 150′ and 150″ described above. In addition, the first and second deposition sources 110 and 180, the first deposition source nozzle unit 120 and the second deposition source nozzle 181, and the patterning slit sheet 150, in one embodiment, are connected to each other by the connection member 135. In the thin film deposition apparatus 100B according to the current embodiment of the present invention, the first deposition source 110 contains a host material 115 and the second deposition source 180 contains a dopant material (not shown) so that the host material 115 and the dopant material may be concurrently (e.g., simultaneously) deposited on the substrate 400.

The thin film deposition apparatus 100B of the current embodiment is different from the thin film deposition apparatus 100″ according to the embodiment described with reference to FIG. 9 in that the second deposition source 180 is a point source, not a linear source. As described above, the dopant material may be contained by about 3 parts to about 20 parts by weight in the thin film forming material (total weight of the host and dopant materials) of 100 parts of weight. That is, since the dopant material is relatively less than the host material in the thin film forming material, it is not necessary to use the linear source having a large capacity for containing the dopant material. Thus, in the thin film deposition apparatus 100B of the current embodiment of the present invention, the first deposition source 110 containing the host material is formed as the linear source, and the second deposition source 180 containing the dopant material is formed as the point source.

In one embodiment, the second deposition source 180 is a single point source, as shown in FIG. 11; however, the present invention is not limited thereto. That is, in other embodiments, a plurality of second deposition sources may be provided according to the content amount of the dopant material that is needed.

As described above, since the second deposition source 180 is formed as the point source, the thin film deposition apparatus 100B may have a simple structure and fabrication costs of the thin film deposition apparatus 100B may be reduced.

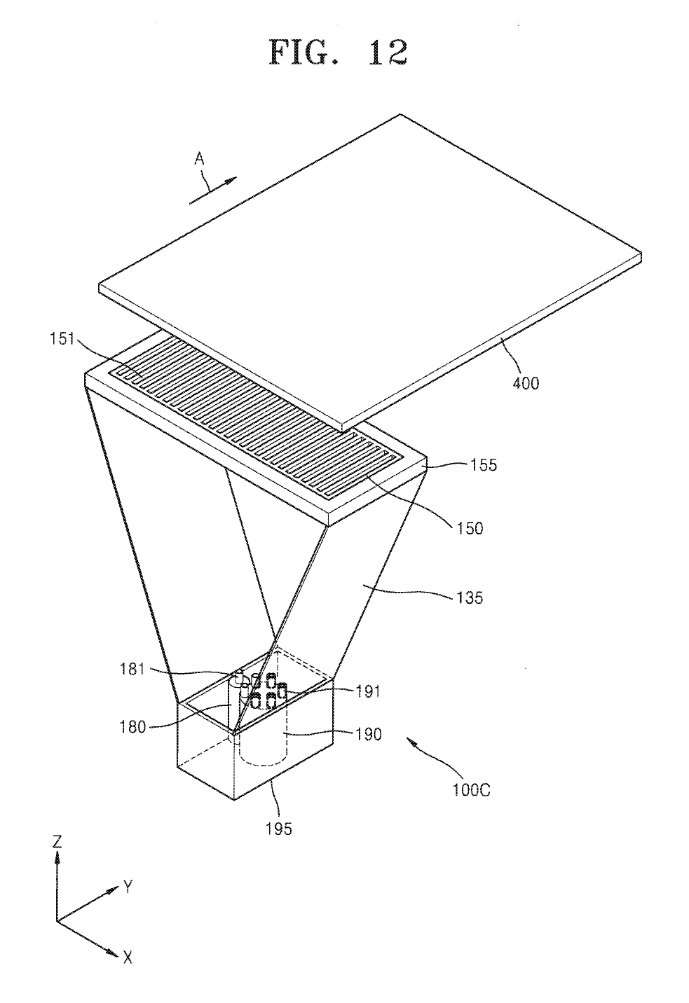

FIG. 12 is a schematic perspective view of a thin film deposition apparatus 100C according to another embodiment of the present invention. Referring to FIG. 12, the thin film deposition apparatus 100C according to the current embodiment of the present invention includes a first deposition source 190, one or more first deposition source nozzles 191, a second deposition source 180, a second deposition source nozzle 181, and the patterning slit sheet 150. The patterning slit sheet 150 and the frame 155 are located between the first and second deposition sources 190 and 180 and the substrate 400, and the patterning slit sheet 150 includes the plurality of patterning slits 151 arranged in the X-axis direction. Alternatively to the patterning slit sheet 150, the thin film deposition apparatus 100C may include one of the patterning slit sheets 150′ and 150″ described above. In addition, the first and second deposition sources 190 and 180 and the deposition source nozzles 181 and 191 are accommodated in a deposition source accommodation unit 195, and the deposition source accommodation unit 195 and the patterning slit sheet 150 may be connected to each other by the connection member 135. In the thin film deposition apparatus 100C according to the current embodiment of the present invention, the first deposition source 190 contains a host material (not shown) and the second deposition source 180 contains a dopant material (not shown) so that the host material and the dopant material may be concurrently (e.g., simultaneously) deposited on the substrate 400.

The thin film deposition apparatus 100C of the current embodiment is different from the thin film deposition apparatus 100B according to the embodiment described with reference to FIG. 11 in that the first deposition source 190 is a point source, not a linear source. In particular, as a distance between the deposition sources 180 and 190 and the substrate 400 is increased, the point source may be more favorable for performing the deposition than the linear source. Therefore, the first deposition source 190 containing the host material and the first deposition source nozzles 191 may be formed as a plurality of point sources, and in particular, the first deposition source 190 on which the first deposition source nozzles 191 are formed may be configured to revolve. As described above, since the first and second deposition sources 190 and 180 are formed as the point sources, the thin film deposition apparatus 100C may have a simple structure and fabrication costs of the thin film deposition apparatus 100 may be reduced.

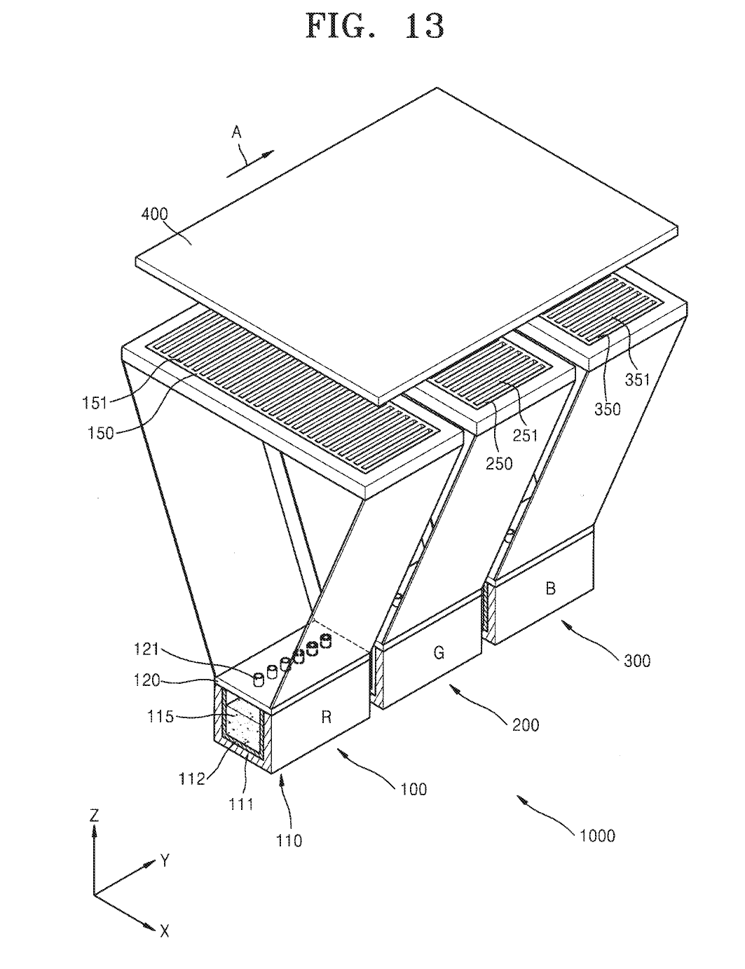

FIG. 13 is a schematic perspective view of a thin film deposition apparatus 100 according to another embodiment of the present invention. Referring to FIG. 13, the thin film deposition apparatus 1000 according to the current embodiment of the present invention includes a plurality of thin film deposition assemblies, each of which may have a same configuration as the thin film deposition apparatus 100 shown in FIGS. 1 through 3. In other words, the thin film deposition apparatus 1000 according to the current embodiment of the present invention may include a multi-deposition source that concurrently (e.g., simultaneously) discharges deposition materials for forming the R emission layer, the G emission layer, and the B emission layer.

In particular, the thin film deposition apparatus 1000 according to the current embodiment of the present invention includes a first thin film deposition assembly 100, a second thin film deposition assembly 200, and a third thin film deposition assembly 300. In one embodiment, each of the first thin film deposition assembly 100, the second thin film deposition assembly 200, and the third thin film deposition assembly 300 has the same structure as the thin film deposition apparatus 100 described with reference to FIGS. 1 through 3, and thus a detailed description thereof will not be repeated.

The deposition sources 110 of the first thin film deposition assembly 100, the second thin film deposition assembly 200 and the third thin film deposition assembly 300 may contain different deposition materials, respectively. The first thin film deposition assembly 100 may contain a deposition material for forming a R emission layer; the second thin film deposition assembly 200 may contain a deposition material for forming a G emission layer; and the third thin film deposition assembly 300 may contain a deposition material for forming a B emission layer.

In other words, in a conventional method of manufacturing an organic light-emitting display device, a separate chamber and mask are used to form each color emission layer. However, when the thin film deposition apparatus 1000 according to the current embodiment of the present invention is used, the R emission layer, the G emission layer, and the B emission layer may be formed concurrently (e.g., at the same time) with a single multi-deposition source. Thus, the amount of time needed to manufacture the organic light-emitting display device is reduced (e.g., significantly reduced). In addition, the organic light-emitting display device 1000 may be manufactured with less chambers, so that equipment costs are also reduced (e.g., significantly reduced).

Although not illustrated, a patterning slit sheet 150 of the first thin film deposition assembly 100, a patterning slit sheet 250 of the second thin film deposition assembly 200, and a patterning slit sheet 350 of the third thin film deposition assembly 300 may be arranged to be offset by a distance (e.g., a same or substantially same distance) with respect to each other, in order for deposition regions corresponding to the patterning slit sheets 150, 250, and 350 not to overlap on the substrate 400. In other words, in one embodiment, when the first thin film deposition assembly 100, the second thin film deposition assembly 200, and the third thin film deposition assembly 300 are used to deposit a R emission layer, a G emission layer and a B emission layer, respectively, patterning slits 151 of the first thin film deposition assembly 100, patterning slits 251 of the second thin film deposition assembly 200, and patterning slits 351 of the third thin film deposition assembly 300 are arranged to not be aligned with respect to each other, in order to form the R emission layer, the G emission layer, and the B emission layer in different regions of the substrate 400.

In addition, the deposition materials for forming the R emission layer, the G emission layer, and the B emission layer may have different deposition temperatures. Therefore, the temperatures of the deposition sources of the respective first, second, and third thin film deposition assemblies 100, 200, and 300 may be set to be different.

Although the thin film deposition apparatus 1000 according to the current embodiment of the present invention includes three thin film deposition assemblies, the present invention is not limited thereto. In other words, a thin film deposition apparatus according to another embodiment of the present invention may include a plurality of thin film deposition assemblies, each of which contains a different deposition material. For example, a thin film deposition apparatus according to another embodiment of the present invention may include five thin film deposition assemblies respectively containing materials for a R emission layer, a G emission layer, a B emission layer, an auxiliary layer (R′) of the R emission layer, and an auxiliary layer (G′) of the G emission layer.

As described above, a plurality of thin films may be formed at the same time with a plurality of thin film deposition assemblies, and thus manufacturing yield and deposition efficiency are improved. In addition, the overall manufacturing process is simplified, and the manufacturing costs are reduced.

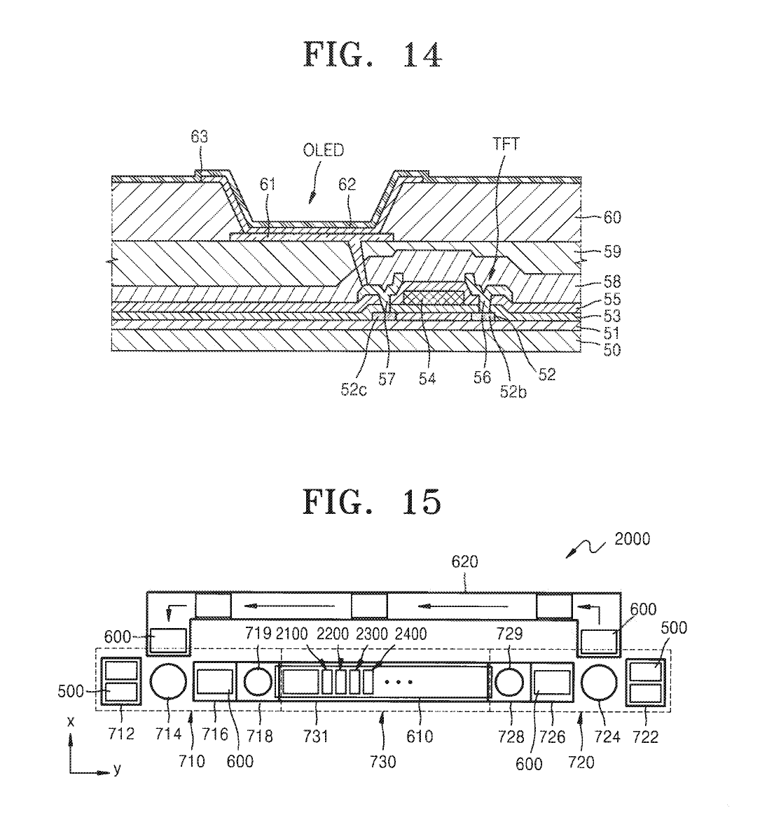

FIG. 14 is a cross-sectional view of an active matrix-type organic light emitting display device fabricated by using a thin film deposition apparatus, according to an embodiment of the present invention.

Referring to FIG. 14, a buffer layer 51 is formed on a substrate 50 formed of glass or plastic. A thin film transistor (TFT) and an organic light emitting display device (OLED) are formed on the buffer layer 51.

An active layer 52 having a pattern (e.g., a predetermined pattern) is formed on the buffer layer 51. A gate insulating layer 53 is formed on the active layer 52, and a gate electrode 54 is formed in a region (e.g., a predetermined region) of the gate insulating layer 53. The gate electrode 54 is connected to a gate line (not shown) that applies a TFT ON/OFF signal. An interlayer insulating layer 55 is formed on the gate electrode 54. Source/drain electrodes 56 and 57 are formed such as to contact source/drain regions 52b and 52c, respectively, of the active layer 52 through contact holes. A passivation layer 58 is formed of SiO₂, SiNₓ, etc. on the source/drain electrodes 56 and 57. A planarization layer 59 is formed of an organic material, such as acryl, polyimide, benzocyclobutene (BCB), etc., on the passivation layer 58. A pixel electrode 61, which functions as an anode of the OLED, is formed on the planarization layer 59, and a pixel defining layer 60 formed of an organic material is formed to cover the pixel electrode 61. An opening is formed in the pixel defining layer 60, and an organic layer 62 is formed on a surface of the pixel defining layer 60 and on a surface of the pixel electrode 61 exposed through the opening. The organic layer 62 includes an emission layer. The present invention is not limited to the structure of the organic light-emitting display device described above, and various structures of organic light-emitting display devices may be applied to the present invention.

The OLED displays predetermined image information by emitting red, green, and blue light as current flows. The OLED includes the pixel electrode 61, which is connected to the drain electrode 56 of the TFT and to which a positive power voltage is applied, a counter electrode 63, which is formed so as to cover the entire sub-pixel and to which a negative power voltage is applied, and the organic layer 62, which is located between the pixel electrode 61 and the counter electrode 63 to emit light.

The pixel electrode 61 and the counter electrode 63 are insulated from each other by the organic layer 62, and respectively apply voltages of opposite polarities to the organic layer 62 to induce light emission in the organic layer 62.

The organic layer 62 may include a low-molecular weight organic layer or a high-molecular weight organic layer. When a low-molecular weight organic layer is used as the organic layer 62, the organic layer 62 may have a single or multi-layer structure including at least one selected from the group consisting of a hole injection layer (HIL), a hole transport layer (HTL), an emission layer (EML), an electron transport layer (ETL), an electron injection layer (EIL), etc. Examples of available organic materials include copper phthalocyanine (CuPc), N,N′-di(naphthalene-1-yl)-N,N′-diphenyl-benzidine (NPB), tris-8-hydroxyquinoline aluminum (Alq3), or the like. The low-molecular weight organic layer may be formed by vacuum deposition.

When a high-molecular weight organic layer is used as the organic layer 62, the organic layer 62 may mostly have a structure including a HTL and an EML. In this case, the HTL may be formed of poly(ethylenedioxythiophene) (PEDOT), and the EML may be formed of polyphenylenevinylenes (PPVs) or polyfluorenes. The HTL and the EML may be formed by screen printing, inkjet printing, or the like.

The organic layer 62 is not limited to the organic layers described above, and may be embodied in various ways.

In one embodiment, the pixel electrode 61 functions as an anode, and the counter electrode 63 functions as a cathode. Alternatively, the pixel electrode 61 may function as a cathode, and the counter electrode 63 may function as an anode.

The pixel electrode 61 may be formed as a transparent electrode or a reflective electrode. Such a transparent electrode may be formed of indium tin oxide (ITO), indium zinc oxide (IZO), zinc oxide (ZnO), or indium oxide (In₂O₃). Such a reflective electrode may be formed by forming a reflective layer from silver (Ag), magnesium (Mg), aluminum (Al), platinum (Pt), palladium (Pd), gold (Au), nickel (Ni), neodymium (Nd), iridium (Ir), chromium (Cr) or a compound thereof and forming a layer of ITO, IZO, ZnO, or In₂O₃ on the reflective layer.

The counter electrode 63 may be formed as a transparent electrode or a reflective electrode. When the counter electrode 63 is formed as a transparent electrode, the counter electrode 63 functions as a cathode. To this end, such a transparent electrode may be formed by depositing a metal having a low work function, such as lithium (Li), calcium (Ca), lithium fluoride/calcium (LiF/Ca), lithium fluoride/aluminum (LiF/AI), aluminum (Al), silver (Ag), magnesium (Mg), or a compound thereof on a surface of the organic layer 62 and forming an auxiliary electrode layer or a bus electrode line thereon from a transparent electrode forming material, such as ITO, IZO, ZnO, In₂O₃, or the like. When the counter electrode 63 is formed as a reflective electrode, the reflective layer may be formed by depositing Li, Ca, LiF/Ca, LiF/AI, Al, Ag, Mg, or a compound thereof on the entire surface of the organic layer 62.

In the organic light-emitting display apparatus described above, the organic layer 62 including the emission layer may be formed by using a thin film deposition apparatus 100 (refer to FIG. 1), which is described above. The thin film deposition apparatuses according to the embodiments of the present invention described above may be applied to form an organic layer or an inorganic layer of an organic TFT, and to form layers from various materials.

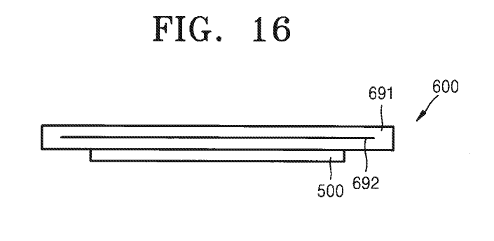

FIG. 15 is a schematic system diagram of a thin film deposition apparatus according to another embodiment of the present invention, and FIG. 16 is a schematic diagram of an electrostatic chuck of the thin film deposition apparatus of FIG. 15.

Referring to FIG. 15, a thin film deposition apparatus 2000 according to the present embodiment includes a loading unit 710, a deposition unit 730, an unloading unit 720, a first circulating unit 610, and a second circulating unit 620.

According to one embodiment, the loading unit 710 may include a first rack 712, an introducing robot 714, an introducing chamber 716, and a first inverting chamber 718.

A plurality of substrates 500 prior to deposition is stacked on the first rack 712. The introducing robot 714 picks up the substrate 500 from the first rack 712, puts the substrate 500 on an electrostatic chuck 600 transported by the second circulating unit 620, and moves the electrostatic chuck 600, to which the substrate 500 is attached, to the introducing chamber 716.

The first inverting chamber 718 is arranged close to the introducing chamber 716. A first inverting robot 719 located in the first inverting chamber 718 inverts the electrostatic chuck 600 and attaches the electrostatic chuck 600 to the first circulating unit 610 of the deposition unit 730.

As shown in FIG. 16, the electrostatic chuck 600, in one embodiment, includes a ceramic main body 691 and an electrode 692 buried therein, where power may be applied to the electrode 692. As a high voltage is applied to the electrode 692, the substrate 500 is attached to a surface of the main body 691.

With reference again to FIG. 15, the introducing robot 714 puts the substrate 500 on the top surface of the electrostatic chuck 600, the electrostatic chuck 600 is transported to the introducing chamber 716, and the first inverting robot 719 inverts the electrostatic chuck 600. Therefore, the substrate 500 is oriented to face downward in the deposition unit 730.

The configuration of the unloading unit 720, according to one embodiment, is opposite to the configuration of the loading unit 710 as described above. In other words, the substrate 500 and the electrostatic chuck 600 carried out from the deposition unit 730 are inverted by a second inverting robot 729 in a second inverting chamber 728 and are transported to an ejecting chamber 726. An ejecting robot 724 removes the substrate 500 and the electrostatic chuck 600 from the ejecting chamber 726, separates the substrate 500 from the electrostatic chuck 600, and stacks the substrate 500 on a second rack 722. The electrostatic chuck 600 separated from the substrate 500 is transported back to the loading unit 710 via the second circulating unit 620.

However, the present invention is not limited thereto, and, in another embodiment, for example, the substrate 500 may be initially attached to the bottom surface of the electrostatic chuck 600 and transported to the deposition unit 730. In this case, the first inverting chamber 718, the first inverting robot 719, the second inverting chamber 728, and the second inverting robot 729 are not necessary.

The deposition unit 730 includes at least one deposition chamber. According to the present embodiment, as shown in FIG. 15, the deposition unit 730 includes a first chamber 731, and a plurality of thin film deposition assemblies 2100, 2200, 2300, and 2400 are arranged in the first chamber 731. Although FIG. 15 shows that four thin film deposition assemblies, that is, a first thin film deposition assembly 2100, a second thin film deposition assembly 2200, a third thin film deposition assembly 2300, and a fourth thin film deposition assembly 2400 are arranged in the first chamber 731, a deposition unit according to embodiments of the present invention may include any other suitable number of thin film deposition assemblies which may be selected according to materials to be deposited and conditions of deposition. In the present embodiment, the first chamber 731 is maintained at a vacuum during deposition.

According to the present embodiment, the electrostatic chuck 600 to which the substrate 500 is attached is transported at least to the deposition unit 730, and, in one embodiment, is transported via the loading unit 710, the deposition unit 730, and the unloading unit 720 in the order stated. The electrostatic chuck 600 separated from the substrate 500 in the unloading unit 720 is transported back to the loading unit 710 by the second circulating unit 620.

The first circulating unit 610 is arranged to penetrate the first chamber 731 while the first circulating unit 610 passes through the deposition unit 730, whereas the second circulating unit 620 is arranged to transport the electrostatic chuck 600.

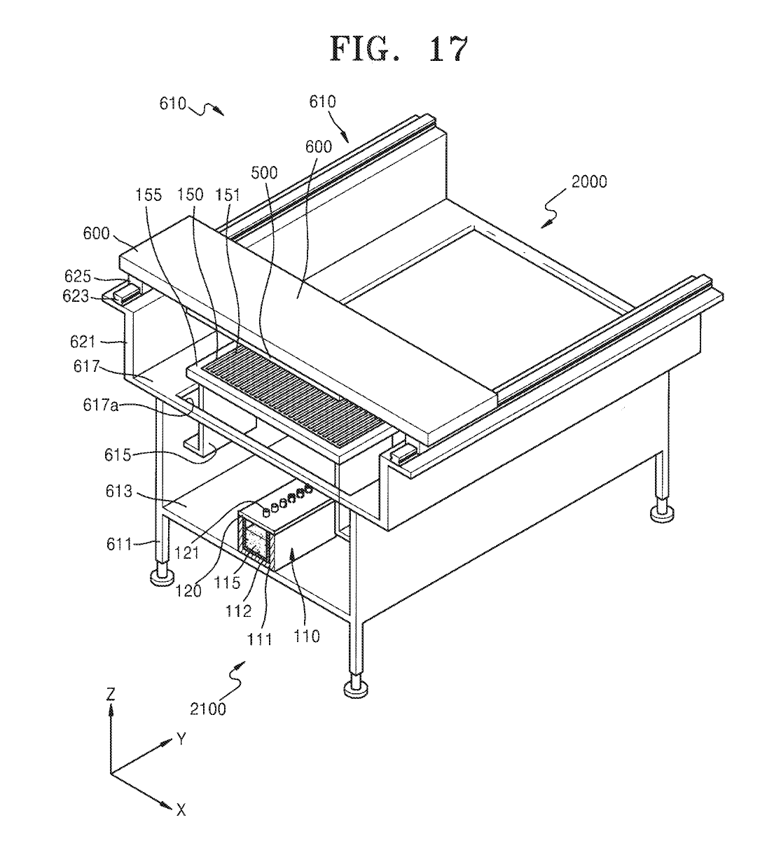

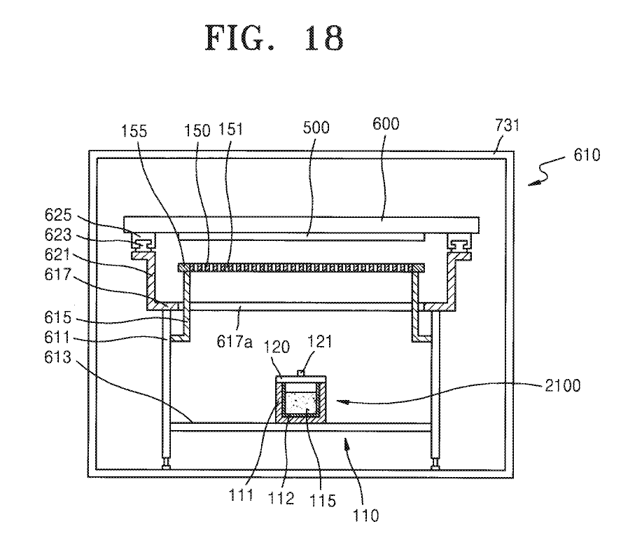

FIG. 17 is a schematic perspective view of the first circulating unit 610 and the first thin film deposition assembly 2100 of the thin film deposition apparatus 2000 of FIG. 15; and FIG. 18 is a front sectional view of the first circulating unit 610 and the first thin film deposition assembly 2100. Here, in FIG. 17, the first chamber 731 is omitted for the sake of clarity.

Referring to FIGS. 17 and 18, as well as FIG. 15 described above, the thin film deposition apparatus according to the present embodiment includes the first circulating unit 610, the deposition unit 730, and the first thin film deposition assembly 2100.

In one embodiment, the first thin film deposition assembly 2100 includes the deposition source 110, the deposition source nozzle unit 120, and the patterning slit sheet 150. Here, the deposition source 110 includes the crucible 111 that is filled with the deposition material 115, and the heater 112 that heats the crucible 111 to vaporize the deposition material 115, which is contained in the crucible 111, toward the deposition source nozzle unit 120. The deposition source nozzle unit 120 is located at a side of the deposition source 110. In addition, the deposition source nozzle unit 120 includes the plurality of deposition source nozzles 121 arranged at intervals (e.g., equal or substantially equal intervals) in the Y-axis direction. The patterning slit sheet 150 and the frame 155 are located between the deposition source 110 and the substrate 500, and the patterning slit sheet 150 includes the plurality of patterning slits 151 arranged in the X-axis direction. Alternatively to the patterning slit sheet 150, the first thin film deposition assembly 2100 may include one of the patterning slit sheets 150′ and 150″ described above. The deposition source 110, the deposition source nozzle unit 120, and the patterning slit sheet 150 may be formed as separate components in the deposition unit 730, instead of being formed as a single body as in some other embodiments described above.

The first circulating unit 610 will now be described in further detail.

The first circulating unit 610 transports the electrostatic chuck 600 having the substrate 500 fixed thereto. According to one embodiment, the first circulating unit 610 includes a frame 611, which includes a bottom plate 613 and a top plate 617, a sheet supporting unit 615 arranged inside the frame 611, a guide supporting unit 621 arranged on top of the frame 611, a pair of guide rails 623 on the guide supporting unit 621, and a plurality of guide blocks 625 on the pair of the guide rails 623.

The frame 611 forms the base of the first circulating unit 610 and, in one embodiment, has a shape of an empty box. Here, the bottom plate 613 forms the bottom surface of the frame 611, and the deposition source 110 may be arranged on the bottom plate 613. Meanwhile, the top plate 617 forms the top surface of the frame 611. An opening 617a may be formed in the top plate 617, such that the deposition material 115 vaporized by the deposition source 110 may pass through the patterning slit sheet 150 and be deposited on the substrate 500. Some or all of the components of the frame 611 as described above may either be formed as separate components and subsequently combined or be initially made as a single body.

Here, although not shown, the bottom plate 613 on which the deposition source 110 is arranged may be formed as a cassette, so that the bottom plate 613 may be pulled out of the frame 611. Therefore, the deposition source 110 may be replaced easily,

The sheet supporting unit 615, in one embodiment, protrudes from an inner surface of the frame 611 and supports the patterning slit sheet 150. Further, the sheet supporting unit 615 may guide movement of the deposition material 115 ejected by the deposition source nozzles 121, such that the deposition material 115 does not spread out (e.g., in the X-direction).

According to embodiments of the present invention, deposition is performed as an electrostatic chuck to which a substrate is attached moves in a straight line inside a chamber, as described above. In this case, conventional means, such as a roller or a conveyer belt, may be utilized. Furthermore, for precise movement of a substrate, a linear motion (LM) system including guide rails and guide blocks may be utilized, as shown in FIGS. 17 and 18.

In one embodiment, the guide supporting unit 621 arranged on the top plate 617 and the pair of the guide rails 623 on the guide supporting unit 621 penetrate the first chamber 731 of the deposition unit 730,

The top surface of the guide supporting unit 621 is flat or almost flat, and the pair of the guide rails 623 are located on the top surface of the guide supporting unit 621. Further, the guide blocks 625 are inserted to the guide rails 623, or vice versa, so that the guide blocks 625 may move back and forth along the guide rails 623.

The guide blocks 625 may include a driving unit (not shown) for moving the guide blocks 625 along the guide rails 623. The driving unit may be either a unit for providing driving force or a unit for transmitting a driving force from a separate driving source to the guide blocks 625.

In one embodiment, an LM system may be configured by arranging LM rails as the guide rails 623 and arranging LM blocks as the guide blocks 625. Compared to a conventional sliding guide system, an LM system is a highly precise transporting system with a relatively small friction coefficient and small location error.

According to the present invention, a mask may be formed to be smaller than a substrate, and deposition may be performed by moving the mask relative to the substrate. Therefore, a mask may be easily manufactured. Furthermore, a defect due to contact between a substrate and a mask may be prevented. Furthermore, a period of time for closely contacting a substrate and a mask to each other is not necessary, and thus the overall manufacturing speed is increased.

Furthermore, the deposition source 110, the deposition source nozzle unit 120, and the patterning slit sheet 150, included in the first thin film deposition assembly 2100 according to an embodiment of the present invention, may be formed as separate components in the deposition unit 730, instead of being formed as a single body. Therefore, inserting and removing the deposition source 110 for refilling of the deposition material 115, and inserting and removing the patterning slit sheet 150 for cleaning or replacement may be easily performed.

As described above, the thin film deposition apparatus according to aspects of the present invention may be easily manufactured and may be simply applied to produce large-sized display devices on a mass scale. The thin film deposition apparatus may improve manufacturing yield and deposition efficiency.

While the present invention has been particularly shown and described with reference to some exemplary embodiments thereof, it will be understood by those of ordinary skill in the art that various changes in form and details may be made therein without departing from the spirit and scope of the present invention as defined by the following claims.

What is claimed is:

1. A thin film deposition apparatus for forming a thin film on a substrate, the apparatus comprising:
a chamber;
a deposition source accommodated in the chamber and configured to discharge a deposition material;
a deposition source nozzle unit located at a side of the deposition source and comprising a plurality of deposition source nozzles arranged in a first direction; and
a patterning slit sheet located opposite the deposition source nozzle unit inside the chamber and including a plurality of patterning slits arranged in a second direction perpendicular to the first direction,
wherein the patterning slit sheet is spaced apart from the substrate, and
wherein the thin film deposition apparatus is configured to perform a deposition while at least one of the substrate or the thin film deposition apparatus moves relative to the other in the first direction.

2. The thin film deposition apparatus of claim 1, further comprising a first circulating unit configured to move an electrostatic chuck having the substrate attached thereto in the first direction.

3. The thin film deposition apparatus of claim 2, wherein the first circulating unit comprises:
a frame accommodating the deposition source; and
a sheet supporting unit protruding from an inner surface of the frame and supporting the patterning slit sheet.

4. The thin film deposition apparatus of claim 3,
wherein an opening is formed in an upper plate of the frame, and
wherein the deposition source is configured to discharge the deposition material through the opening and the patterning slit sheet and deposit the deposition material on the substrate.

5. The thin film deposition apparatus of claim 3, wherein the deposition source is on a lower plate of the frame that is located below the upper plate.

6. The thin film deposition apparatus of claim 3, wherein the sheet supporting unit guides movement of the deposition material.

7. The thin film deposition apparatus of claim 3, wherein the first circulating unit further comprises:
a guide supporting unit on the frame;
a pair of guide rails arranged parallel to each other on the guide supporting unit; and
one or more guide blocks combined with the guide rails.

8. The thin film deposition apparatus of claim 7, wherein the electrostatic chuck having the substrate attached thereto is arranged on the guide blocks and is configured to move the substrate back and forth in a straight line along the guide rails.

9. The thin film deposition apparatus of claim 2, further comprising:
a loading unit configured to attach the substrate to the electrostatic chuck; and
an unloading unit configured to separate the substrate from the electrostatic chuck after the deposition has been performed.

10. The thin film deposition apparatus of claim 2, wherein the deposition source is configured to continuously deposit the deposition material on the substrate while the at least one of the substrate or the thin film deposition apparatus is moved relative to the other in the first direction.

11. The thin film deposition apparatus of claim 1, wherein the patterning slit sheet is smaller than the substrate.

12. The thin film deposition apparatus of claim 1, wherein the thin film deposition apparatus comprises a plurality of thin film deposition assemblies, and each of the thin film deposition assemblies comprises:
the deposition source;
the deposition source nozzle unit; and
the patterning slit sheet.

13. The thin film deposition apparatus of claim 12, wherein the deposition sources of the plurality of thin film deposition assemblies respectively contain different deposition materials.

14. The thin film deposition apparatus of claim 13, wherein thin film deposition assemblies of the plurality of thin film deposition assemblies are configured to concurrently deposit the deposition materials contained in the respective deposition sources of the thin film deposition assemblies on the substrate.

15. The thin film deposition apparatus of claim 12, wherein the plurality of thin film deposition assemblies comprises at least three thin film deposition assemblies, and deposition materials respectively contained in the deposition sources of the at least three thin film deposition assemblies comprise materials for forming red, green, and blue emission layers.

16. The thin film deposition apparatus of claim 12, wherein deposition temperatures of the deposition sources of the plurality of thin film deposition assemblies are separately controllable.

17. The thin film deposition apparatus of claim 12, wherein deposition amounts of the deposition materials discharged from the deposition sources of the plurality of thin film deposition assemblies are separately controllable.

18. A method of manufacturing a thin film on a substrate, the method comprising:
discharging a deposition material from a deposition source through a plurality of first deposition source nozzles arranged in a first direction;
arranging a patterning slit sheet having a plurality of patterning slits arranged in a second direction perpendicular to the first direction opposite the plurality of first deposition source nozzles and spaced apart from the substrate;
passing the deposition material through the plurality of patterning slits of the patterning slit sheet and onto the substrate; and
moving the substrate relative to the plurality of first deposition source nozzles and the patterning slit sheet in the first direction.

19. The method of claim 18, further comprising:
attaching the substrate to an electrostatic chuck; and
moving the electrostatic chuck relative to the plurality of first deposition source nozzles and the patterning slit sheet in the first direction.

20. The method of claim 18, further comprising:
discharging another deposition material from another deposition source through a plurality of second deposition source nozzles arranged in the first direction;
arranging another patterning slit sheet having a plurality of patterning slits arranged in the second direction opposite the plurality of second deposition source nozzles and spaced apart from the substrate;
passing the another deposition material through the plurality of patterning slits of the another patterning slit sheet and onto the substrate concurrently with passing the deposition material through the plurality of patterning slits of the patterning slit sheet and onto the substrate; and
moving the substrate relative to the plurality of second deposition source nozzles and the another patterning slit sheet in the first direction.
